(19) United States
(12) Patent Application Publication
(10) Pub. No.: US 2011/0314789 A1
(43) Pub. Date: Dec. 29, 2011

(54) REGENERATOR FOR A THERMAL CYCLE ENGINE

(75) Inventor: Frank Verschaeve, Otegem (BE)

(73) Assignee: NV Bekaert SA

(21) Appl. No.: 13/255,454

(22) PCT Filed: Mar. 9, 2010
(86) PCT No.: PCT/EP10/52954

§ 371 Date: Sep. 8, 2011

(30) Foreign Application Priority Data
Mar. 24, 2009 (EP) 09155947.6

(51) Int. Cl. F02G 1/057; B21K 3/00

(52) U.S. Cl. 60/39.512; 29/888.01

(57) ABSTRACT

A regenerator (100) for a thermal cycle engine with external combustion, according to the invention comprises a network of fibers wherein a majority of the fibers at least partially encircles the axis of the regenerator. The fibers were part of a fiber web, which is coiled and sintered thereby obtaining the regenerator.

### TECHNICAL FIELD

The present invention relates to a regenerator for a thermal cycle engine with external combustion, such as a Stirling cycle heat engine. More in particular, the present invention relates to an improved regenerator for a thermal cycle engine.

The invention further relates to methods for obtaining such a regenerator and the use of such regenerator in a thermal cycle engine.

### BACKGROUND ART

A regenerator is used in a thermal cycle machine to add and remove heat from the working fluid during different phases of the thermal cycle. Such regenerators must be capable of high heat transfer rates which typically suggests a high heat transfer area and low flow resistance to the working fluid.

Different types of regenerators are already available on the market. Typically such regenerators comprise metal screens, cylindrically wound wire gauze or 3D random fiber networks as e.g. described in JP1240760, JP2091463 and WO01/65099; or even short metal fibers as e.g. described in EP1341630.

A regenerator needs to have a very low thermal conductivity in the fluid flow direction; since one end of the regenerator is hot and the other end is cold. The regenerator also needs to have very high thermal conductivity in the direction normal to the fluid flow so that the working fluid can rapidly adjust itself to the local temperature inside the regenerator. The regenerator must also have a very large surface area to improve the rate of heat movement with the working fluid. Finally, the regenerator must have a low loss flow path, for the working fluid, so that minimal pressure drop will result as the working fluid moves through. In case the regenerator is made of fibers, the regenerator must be fabricated in such a manner as to prohibit fiber migration as fragments might be entrained in the working fluid and transported to the compression or expansion cylinders and result in damage to the piston seals.

Accordingly, this invention seeks to provide a new regenerator and method of making such a regenerator, which embodies the properties indicated above. Furthermore, this invention seeks to provide a regenerator which can be fitted into a stirling engine, using a minimum of adjustment.

### DISCLOSURE OF INVENTION

Particular and preferred aspects of the invention are set out in the accompanying independent and dependent claims. Combinations of features from the dependent claims may be combined with features of the independent claims as appropriate and not merely as explicitly set out in the claims.

According to some embodiments of the present invention, at least 50% of the fibers in the regenerator at least partially encircle the axis.

The term “encircle” is to be understood as to pass around. Hence “a fiber which at least partially encircles the axis” means that the fiber at least partially passes around the axis. This may best be seen by projecting the fiber in the direction of the average flow path on a plane AA′, being perpendicular to the average flow path. The projection line of the fiber, projected in the direction of the average flow path on a plane AA′, being perpendicular to the average flow path, is not necessarily circular or to be an arc of a circle, having its centre coinciding with the projection of the axis on this plane AA′. The best fitting line, i.e. the line which fits closest to the projection line of the fiber, projected in the direction of the average flow path on a plane AA′, being perpendicular to the average flow path, has its concave side oriented to the projection of the axis on this plane AA′.

The regenerator, comprising fibers, which are optionally metal fibers, has a porosity P, which may range from 70% to 99%. In comparison with regenerators comprising fibers in an identical volume, with identical porosity and provided from identical fibers, but having its fibers oriented parallel to a plane perpendicular to the flow path, a significant increase of air permeability for the regenerator element according to the first aspect of the present invention is obtained. An increase of more than 10% can be obtained. This higher air permeability for given fiber properties (such as mantle surface, equivalent diameter average cross section profile and the like) and for given regenerator properties, such as porosity of the regenerator built from fibers, is particularly advantageous in case the regenerator is used to exchange heat in a thermal cycle engine, e.g. a Stirling cycle heat engine. This high air permeability results in a minimal pressure drop.

According to some embodiments of the present invention, the regenerator may be cylindrical. The regenerator may optionally be conical, e.g. having circular or an elliptical cross section. For cylindrical regenerators, optionally the regenerator may be cylindrical with a circular or an elliptical cross section.

According to a first aspect of the present invention, a majority of fibers substantially may extend at least in the axial direction of the regenerator. At least 50% of the fibers present in the regenerator substantially may extend at least in the axial direction of the regenerator. According to the first aspect of the present invention, the fibers are part of a fiber web, which is coiled about a coiling axis being substantially parallel to the average flow direction of the working fluid. This results in that the majority of said fibers are randomly spread in a tangential plane encircling said axis. The fiber web may be a fiber web obtained by any suitable web forming process, such as air laid web, wet laid web or a carded web. The web is preferably a nonwoven web, optionally needle punched.

According to the first aspect of the present invention, the regenerator can be in the form of a ring, as e.g. is used in a free piston Stirling cycle engine. The regenerator might also be in the form of a disc, as e.g. is used in an alpha type Stirling engine.

Any suitable type of metal or metal alloy may be used to provide the metal fibers. The metal fibers are for example made of steel such as stainless steel. Optionally stainless steel alloys are AISI 300 or AISI 400-serie alloys, such as AISI 316L or AISI 347, or alloys comprising Fe, Al and Cr, stainless steel comprising chromium, aluminium and/or nickel and 0.05 to 0.3% by weight of yttrium, cerium, lanthanum, hafnium or titanium, such as e. g. DIN1.4767 alloys or FeCrAlloy®, are used. Also copper or copper-alloys, or titanium or titanium alloys may be used. The metal fibers can also be made of nickel or a nickel alloy.

Metal fibers may be made by any presently known metal fiber production method, e.g. by bundle drawing operation, by coil shaving operation as described in JP3083144, by wire shaving operations (such as steel wool) or by a method providing metal fibers from a bath of molten metal alloy. In order to provide the metal fibers with their average length, the metal fibers may be cut using the method as described in WO02/057035, or may be stretch broken.

Preferably the equivalent diameter D of the metal fibers is less than 100 μm such as less than 65 μm, more preferably less than 36 μm such as 35 μm, 22 μm or 17 μm. Optionally the equivalent diameter of the metal fibers is less than 15 μm, such as 14 μm, 12 μm or 11 μm, or even less than 9 μm such as e.g. 8 μm. Optionally the equivalent diameter D of the metal fibers is less than 7 μm or less than 6 μm, e. g. less than 5 μm, such as 1 μm, 1.5 μm, 2 μm, 3 μm, 3.5 μm, or 4 μm.

The metal fibers may have an average fiber length Lfiber, optionally ranging from e.g. 0.6 cm to 6 cm. Preferably, the metal fibers have an average fiber length Lfiber of 0.8 cm to 5 cm, more preferably an average fiber length Lfiber of 1 cm to 3 cm.

The web may be provided by air laid or wet laid processes. The metal fiber web may e.g. have a thickness of 1 mm to 50 mm and a surface weight of 20 g/m² to 2000 g/m², more preferably the surface weight of the metal fiber web is ranging between 100 g/m² to 600 g/m².

The regenerator has a porosity ranging between 70% and 99%, more preferably the regenerator has a porosity ranging between 80 and 98%, most preferably the regenerator has a porosity ranging between 85 and 95%.

According to a second aspect of the present invention, a method to provide a regenerator is provided. This method for manufacturing a regenerator for a thermal cycle engine obtains a regenerator with an outer diameter. The method comprises the steps of:
providing a fiber web having at least a leading edge;
cylindrically winding said fiber web, parallel to said leading edge, until the predetermined diameter, being said outer diameter of said regenerator, is obtained;
providing a mesh having at least a mesh leading edge;
cylindrically winding said mesh around said wound fiber web, parallel to said mesh leading edge;
sintering the wound web in such a manner as to cross-link the fibers at points of close contact between said fibers;
removing said mesh from around the sintered regenerator.

According to an alternative second aspect of the present invention, a method to provide a regenerator is provided. This method for manufacturing a regenerator for a thermal cycle engine obtains a regenerator with an inner and an outer diameter. The method comprises the steps of:
providing a fiber web having at least a leading edge;
providing a reel, said reel having a diameter almost equal to the internal diameter of said regenerator;
cylindrically winding said fiber web onto said reel, parallel to said leading edge, until the predetermined diameter, being said outer diameter of said regenerator, is obtained;
providing a mesh having at least a mesh leading edge;
cylindrically winding said mesh around said wound fiber web, parallel to said mesh leading edge, thereby obtaining a wound fiber web within a sintering mal which is provided by said reel and said mesh;
sintering the wound web in such a manner as to cross-link the fibers at points of close contact between said fibers;
removing said mesh and said reel from around the sintered regenerator.

The mesh used as part of the sintering mal can also be replaced by a foil or plate, suitable for use in sintering. Preferably, the mesh, foil or plate, and the reel, if present, were subjected to a treatment which prevents that the mesh, foil or plate, nor the reel are sintered onto the regenerator.

In another preferred embodiment, the reel can be replaced by part of the cylinder head or an engine part, around which the regenerator is produced and which is not removed after the sintering step.

As such a regenerator is provided, defining a regenerator volume filled with fiber material. Due to the use of the relatively long fibers, combined with the winding operation, no fiber migration will occur. This also makes the use of meshes at the in- and outflow sides of the regenerator obsolete.

Preferably, the sintering is a soft sintering, which allows the regenerator to be fit into the thermal cycle engine in an easy way, e.g. by pressing, without the need for a machining step.

Preferably, the regenerator is produced with an outer diameter being slightly bigger than the space available in the thermal cycle engine, which provides a tension between the soft sintered regenerator and the thermal cycle engine. This tension provides a seamless filling of the regenerator space in the thermal cycle engine, thereby avoiding preferential airflows which would otherwise occur at places where no or less fibers are available. The same reasoning goes for the inner diameter of the regenerator, when present.

The coiling operation can be done in many different ways and are known by the person skilled in the art as e.g. described in U.S. Pat. No. 3,505,038.

The regenerator comprises fibers of which a majority of the fibers, such as at least 50%, at least partially encircle the axis, according to the first aspect of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

The teachings of the present invention permit the design of improved regenerators for use in thermal cycle engines with external combustion, e.g. stirling engines. The reduced pressure drop over the regenerator, due to the increased air permeability, causes a low loss flow path for the working fluid. By the use of fibers and their use in a regenerator with porosities of 70 to 99%, a large surface area is obtained. This large surface area improves the rate of heat movement with the working fluid.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### DEFINITIONS

The term “porosity” P is to be understood as P=100*(1−d) wherein d=(weight of 1 m³ sintered metal fiber web)/(SF) wherein SF=specific weight per m³ of alloy out of which the metal fibers of the sintered metal fiber web are provided.

The “air permeability” (also referred to as AP) is measured using the apparatuses as described in NF 95-352, being the equivalent of ISO 4002.

The term “equivalent diameter” of a particular fiber is to be understood as the diameter of an imaginary fiber having a circular radial cross section, which cross section having a surface area identical to the average of the surface areas of cross sections of the particular fiber.

The term “soft sintering” is to be understood as a sintering wherein the temperatures used are 20 to 100° C. lower than in a normal sintering process, in order to achieve a product wherein the fibers are bonded to each other at points of close contact, but wherein the product has still some flexibility and deformability.

### BRIEF DESCRIPTION OF DRAWINGS

Example embodiments of the invention are described hereinafter with reference to the accompanying drawings in which

FIGS. 1a to 1d and 2a to 2c show schematically consecutive steps of a method to provide regenerators according to different aspects of the present invention.

FIG. 3 shows views of the projections of fibers present in an exemplary regenerator according to the present invention.

In the different figures, the same reference signs refer to the same or analogous elements.

### MODE(S) FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

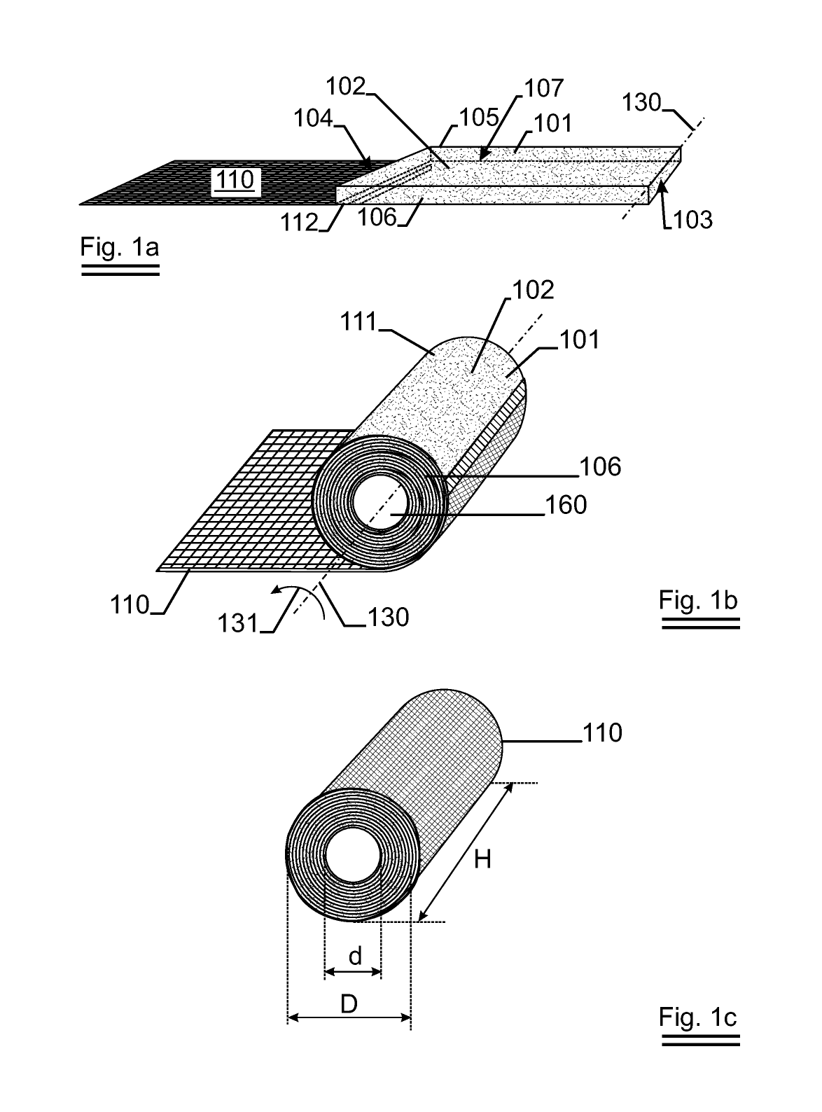

Consecutive steps to provide a regenerator according to the second aspect of the present invention are shown in FIGS. 1a to 1d. As shown in a first step in FIG. 1a, a fiber web 101 is provided, which web 101 comprises fibers 102. The fiber web, has a leading edge 103, a tailing edge 104 and two side edges 105 and 106. In this exemplary embodiment, the fiber web 101 is a substantially rectangular fiber web. Some examples of fiber webs suitable are, e.g. random air laid webs of coil shaved metal fibers of equivalent diameter 35 μm. The web has a width of e.g. between 10 mm to 150 mm and a surface weight of about 300 g/m². An alternative is a random air laid web of coil shaved metal fibers of equivalent diameter 22 μm. The web has a width of e.g. between 10 mm to 150 mm and a surface weight of about 450 g/m². A further alternative is a random air laid web of bundle drawn metal fibers of equivalent diameter 22 μm. The web has a width of e.g. between 10 mm to 150 mm and a surface weight of about 450 g/m². A further alternative is a random air laid web of bundle drawn metal fibers of equivalent diameter 12 μm. The web has a width of e.g. between 10 mm to 150 mm and a surface weight of about 200 g/m².

The fibers 102 in the fiber web 101 are substantially oriented in a plane, which is parallel to the web surface 107. In the plane, the orientation of the fibers is random. Some fibers are substantially aligned with the tailing or leading edge, others are extending in a direction parallel to the side edge, still others have an orientation in between.

The fiber web 101 is now wound or coiled about a reel 160 with coiling axis 130, which coiling axis 130 is parallel to the leading edge 103. The winding is done according to a direction as indicated with arrow 131. During winding, as the fiber web 101 is substantially rectangular, the side edges 105 respectively 106 may be kept aligned so they, once coiled, are present in one plane. It is self evident that also other shapes of fiber webs might be wound and that the sides of the wound web might be cut to the appropriate regenerator length. The coiled fiber web is further surrounded by a mesh 110. Thereafter, the coiled fiber web surrounded by the mesh 110 is put in a sinter furnace for further consolidating the fiber structure. After the soft sintering operation the reel 160 and mesh 110 are removed and a fairly rigid but still flexible and highly porous regenerator 100 is obtained, as shown in FIG. 1d. The regenerator 100 has a height H, an inner diameter d and an outer diameter D.

As such a regenerator 100 is provided, as shown in FIG. 1d, with an inflow side 151 and an outflow side 152 defining an average flow direction 153. The regenerator 100, being cylindrical, has its axis, which is identical to the coiling axis 130, substantially parallel to the average flow direction 153.

As will be explained further in detail, a majority of the fibers 102 at least partially encircle the axis 130. This because the fibers were present in the web and were oriented substantially parallel to the web surface 107. As the web surface 107 now is transformed into a spiral, spiralling about axis 130, the fibers, which were coplanar with the web surface 107, will follow a path, which encircles at least partially the axis 130 according to this spiral. The fibers, which were present in the web according to a direction, which direction had a component parallel to the tailing or leading edge, will at least partially encircle the axis 130. The fibers, which were present in the web according to a direction, which direction had a component parallel to the side edges, will at least partially extend in the axial direction of the regenerator 100.

The fiber web 101 is coiled in such a way that the regenerator has an outer diameter D and an inner diameter d. Some examples of such regenerators according to the present invention are given in Table 1.

TABLE I

| | exemplary regenerator | | | |
|---|---|---|---|---|
| | 1^{st} | 2^{nd} | 3^{rd} | 4^{th} |
| Outer diameter D in mm | 186 | 110 | 137 | 110 |
| Inner diameter d in mm | 131 | 86 | 103 | / |
| height H in mm | 33 | 58 | 32 | 58 |
| Porosity in % | 85 | 90 | 90 | 90 |
| type of fiber used | shaved | bundle | bundle | bundle |
| | | drawn | drawn | drawn |
| Fiber Equivalent diameter in μm | 22 | 30 | 22 | 30 |

The regenerator material can have a porosity of e.g. 85%, 86%, 87%, 88%, 89%, 90%, 91%, 92%, 93%, 94% or 95%. An air permeability of 225 l/dm²/min could be measured using a pressure drop of 200 Pa between the inflow side 151 and the outflow side 152, which is dependent on among others the fiber equivalent diameter, the height of the regenerator and the porosity.

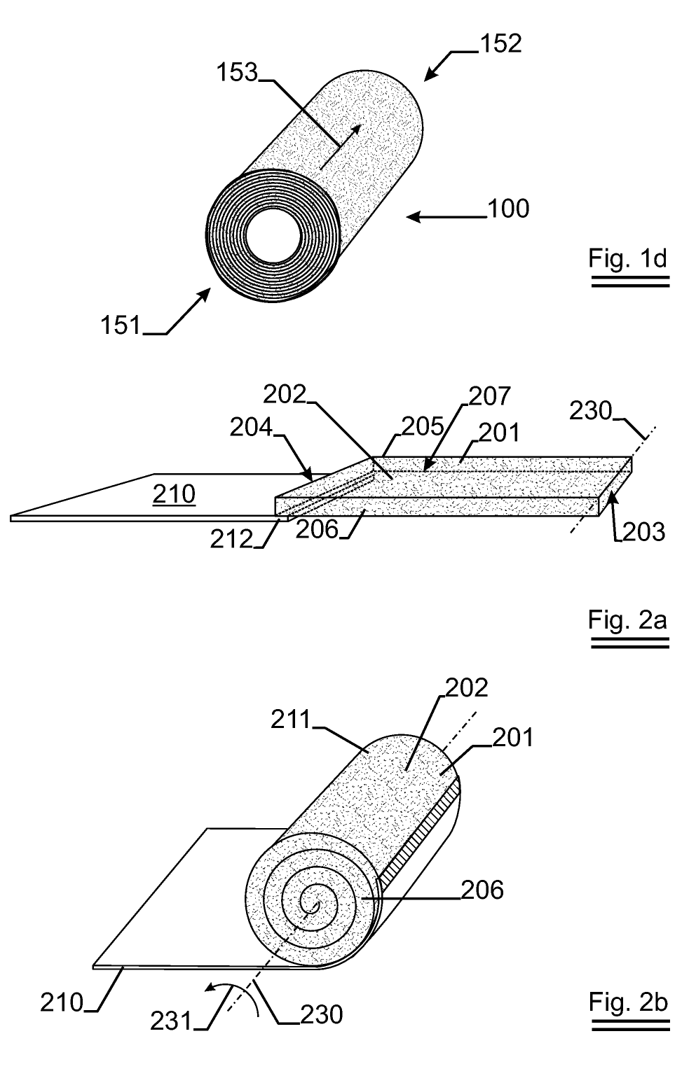

An alternative regenerator according to a first aspect of the present invention may be provided by a method of which consecutive steps are shown in FIGS. 2a to 2c. In this exemplary embodiment, the fiber web 201 is in a rectangular shape and rolled in the same manner as described for FIG. 1, with the only difference that no reel is used, thus coiling the fiber web 201 with coiling axis 230. Thereafter a foil 210 is wound around the wound fiber web 201, as shown in FIGS. 2b and 2c. This product is than soft sintered. After the sintering step, the foil 210 is removed and a disc shaped regenerator is thus provided, not shown.

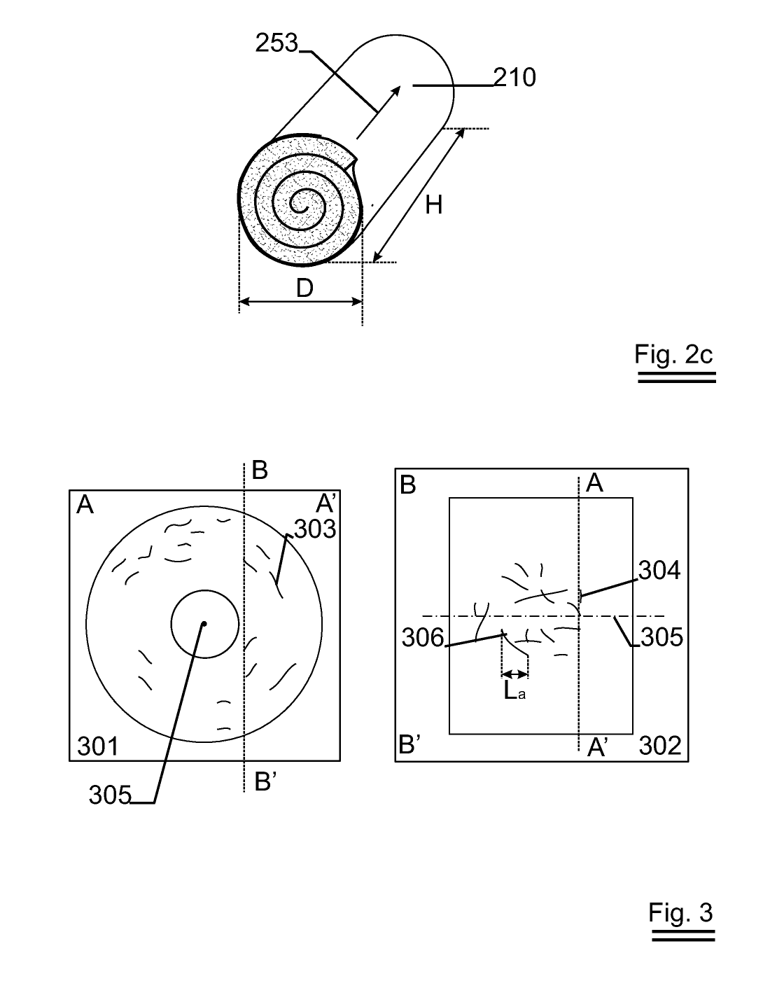

FIG. 3 corresponds to regenerator 100 of FIG. 1. 305 represents the projection of the axis 130. 301 in FIG. 3 shows schematically the projection line 303 of some fibers, projected in the direction of the average flow path 153, on a plane AA′, being perpendicular to the average flow path 300.

302 in FIG. 3 shows schematically the projection line 304 of some fibers, on a plane BB′, comprising the average flow path projected in the direction perpendicular to this is plane BB′.

As is clear from 301, the projections of the fibers on a plane AA′ show a path which at least partially encircle the projection 305 of the axis. Hence, the fibers, which were projected on the plane AA′, thus encircle the axis at least partially as well, seen in 3D. The concave side of the best fitting line is oriented to the projection 305.

As is clear from 302, the projections of the fibers on a plane BB′ show a path which has a component extending in axial direction. As an example, the fiber, whose projection is represented by 306, extends in axial direction along a length La.

Other arrangements for accomplishing the objectives of the methods and regenerators embodying the invention will be obvious for those skilled in the art. It is to be understood that although preferred embodiments, specific constructions and configurations, as well as materials, have been discussed herein for devices according to the present invention, various changes or modifications in form and detail may be made without departing from the scope of this invention as defined by the appended claims.

1. A regenerator for a thermal cycle engine, the regenerator having an axis, said regenerator comprising a network of metal fibers characterized in that said fibers have an average fiber length Lfiber ranging from 0.6 cm to 6 cm and a majority of said fibers are randomly spread in a tangential plane encircling said axis.

2. A regenerator for a thermal cycle engine as in claim 1, wherein said fibers are part of a fiber web which is coiled about said axis.

3. A regenerator according to claim 1, said fibers being mutually interconnected at points of close contact by a sinterbond.

4. A regenerator according to claim 1, wherein the porosity of said regenerator is in the range from 85 to 95%.

5. A regenerator according to claim 1, wherein said regenerator is in the form of a ring.

6. A regenerator according to claim 1, wherein said regenerator is in the form of a disc.

7. A method for manufacturing a regenerator according to claim 1, said regenerator having an outer diameter, the method comprising:
providing a fiber web having at least a leading edge;
cylindrically winding said fiber web, parallel to said leading edge, until the predetermined diameter, being said outer diameter of said regenerator, is obtained;
providing a mesh having at least a mesh leading edge;
cylindrically winding said mesh around said wound fiber web, parallel to said mesh leading edge;
sintering the wound web in such a manner as to cross-link the fibers at points of close contact between said fibers;
removing said mesh from around the sintered regenerator.

8. A method for manufacturing a regenerator according to claim 1, said regenerator having an inner and an outer diameter, the method comprising:
providing a fiber web having at least a leading edge;
providing a reel, said reel having a diameter almost equal to the internal diameter of said regenerator;
cylindrically winding said fiber web onto said reel, parallel to said leading edge, until the predetermined diameter, being said outer diameter of said regenerator, is obtained;
providing a mesh having at least a mesh leading edge;
cylindrically winding said mesh around said wound fiber web, parallel to said mesh leading edge;
sintering the wound web in such a manner as to cross-link the fibers at points of close contact between said fibers;
removing said mesh and reel from around the sintered regenerator.

9. Use of the regenerator as described in claim 1 in a thermal cycle engine with external combustion.

10. Use of the regenerator as obtained in the method of claim 7, in a thermal cycle engine with external combustion.

11. A regenerator according to claim 2, said fibers being mutually interconnected at points of close contact by a sinterbond.

12. Use of the regenerator as obtained in the method of claim 8, in a thermal cycle engine with external combustion.
